(19) United States
(12) Patent Application Publication
(10) Pub. No.: US 2011/0267574 A1
(43) Pub. Date: Nov. 3, 2011

(54) LIQUID CRYSTAL DISPLAY DEVICE AND COMPOSITION FOR FORMING LIQUID CRYSTAL LAYER

(76) Inventors: Yuichi Kawahira, Osaka (JP); Masanobu Mizusaki, Osaka (JP); Yohei Nakanishi, Osaka (JP)

(21) Appl. No.: 13/144,044

(22) PCT Filed: Dec. 25, 2009
(86) PCT No.: PCT/JP2009/071580

§ 371 Date: Jul. 11, 2011

(30) Foreign Application Priority Data
Jan. 9, 2009 (JP) 2009-003821

(51) Int. Cl. G02F 1/1333

(52) U.S. Cl. 349/158

(57) ABSTRACT

The present invention provides a liquid crystal display device and a composition for forming a liquid crystal layer, which can sufficiently reduce image sticking without increasing the number of production processes. The present invention directs to a liquid crystal display device including a pair of substrates, and a liquid crystal layer sandwiched between the pair of substrates, wherein at least one of the pair of substrates has a photopolymer film formed by polymerizing a photopolymerizable monomer, on a surface on the liquid crystal layer side, and the photopolymer film contains a first monomer unit having a structure in which three benzene rings are condensed.

### TECHNICAL FIELD

The present invention relates to a liquid crystal display device and a composition for forming a liquid crystal layer. More specifically, the present invention relates to a liquid crystal display device and a composition for forming a liquid crystal layer which suitably reduce image sticking.

### BACKGROUND ART

A liquid crystal display panel provided in a liquid crystal display device controls the alignment of liquid crystal molecules having birefringence to control passing/blocking of light (ON/OFF of display). Examples of the technology to align liquid crystal molecules include rubbing and photo-alignment using a photo-alignment film. Meanwhile, there are also methods, such as the MVA (multi-domain vertical alignment) mode, which eliminate the need for the alignment process, by controlling the liquid crystal molecule alignment using vertical alignment film(s) and objects for alignment control such as a bank (projection) and a slit formed on an ITO film (ITO slit).

In an MVA liquid crystal display device, the banks (projections) and ITO slits are complexly arranged such that the liquid crystal molecules may, for a wide viewing angle, tilt in four directions when a voltage is applied. The light transmittance therefore tends to be low. The light transmittance can be increased by simplifying the arrangement and widening the gap between banks or between ITO slits. However, if the gap between banks or between ITO slits is very wide, it takes time for all the liquid crystal molecules to tilt, which slows down the response of the device when a voltage is applied to the device for display.

In order to solve the problem of the slow response, a technology has been used which involves polymerizing a polymerizable monomer to form a polymer film on the alignment film, and making the polymer film sustain (memorize) the direction(s) in which the liquid crystal molecules are to tilt (hereinafter, the technology is also referred to as “PSA (Polymer Sustained Alignment) technology”).

Generally, liquid crystal display devices more or less cause image sticking which is a phenomenon that display of the same image for a long period of time results in persistent display of this image even if the display image is changed to another image. Such image sticking has still been an unavoidable problem in liquid crystal displays produced by the PSA technology.

In contrast, liquid crystal display devices reducing image sticking, specifically ones in the MVA mode have been provided. For example, Patent Document 1 discloses a liquid crystal display device having two substrates each with a transparent electrode and an alignment control film for aligning liquid crystal molecules, and a liquid crystal composition provided between the substrates. This liquid crystal display device is produced through the steps of injecting the liquid crystal composition containing a polymerizable monomer between the two substrates, and polymerizing the monomer while applying a voltage between the transparent electrodes facing each other on the substrates. Here, the polymerizable monomer contained in the liquid crystal composition has at least one ring structure or condensed ring structure to which two functional groups are directly bonded. Patent Document 1 also discloses a structure in which two benzene rings are condensed (hereinafter also referred to simply as “two-ring structure”).

Also, liquid crystal display panels that are produced by photo-alignment and the PSA technology and reduce image sticking have been provided. For example, Patent Document 2 discloses a liquid crystal display panel that has a pair of substrates on at least one of which a first alignment layer and a second alignment layer are laminated in this order; and a liquid crystal layer sandwiched by the pair of substrates. In the liquid crystal display panel, the first alignment layer is a photo-alignment layer, and the second alignment layer is formed to cover the surface of the first alignment layer on the liquid crystal layer side.

Further, plasma address liquid crystal display devices reducing image sticking have also been disclosed. For example, Patent Document 3 discloses a liquid crystal display device having a substrate; a dielectric layer; a liquid crystal layer sandwiched by the substrate and the dielectric layer; multiple electrodes arranged in parallel to each other in a stripe form in a first direction on the liquid crystal layer side of the substrate; and multiple plasma channels that are arranged to face the electrodes through the liquid crystal layer and the dielectric layer and in parallel to each other in a stripe form in a second direction different from the first direction. The liquid crystal display device also has multiple dot regions formed in respective regions in which the electrodes and the plasma channels intersect with each other. Here, the dielectric layer selectively reduces ultraviolet light emitted by the plasma channels.

### [Patent Document 1]

Japanese Kokai Publication No. 2003-307720

### [Patent Document 2]

Japanese Kokai Publication No. 2008-76950

### [Patent Document 3]

Japanese Kokai Publication No. 2001-166282

### DISCLOSURE OF THE INVENTION

The technologies disclosed in Patent Documents 1 and 2 unfortunately do not provide sufficient effect of reducing image sticking. Particularly the technology disclosed in Patent Document 1 still leaves image sticking which can be observed even by eye.

The technology disclosed in Patent Document 3, meanwhile, requires a process of preparing a dielectric layer in addition to the usual processes for producing a plasma address liquid crystal display device.

The present invention has been made in view of the above state of the art, and aims to provide a liquid crystal display device and a composition for a liquid crystal layer which can sufficiently reduce image sticking without increasing the number of production processes.

The present inventors have made various studies on liquid crystal display devices capable of sufficiently reducing image sticking without increasing the number of production processes. Firstly, the present inventors have studied the cause of the conventional image sticking. FIG. 11 is a schematic cross-sectional view illustrating a liquid crystal display panel employing the conventional PSA technology: FIG. 11(a) illustrates the state before polymerization of a photopolymerizable monomer; and FIG. 11(b) illustrates the state after the polymerization of the photopolymerizable monomer. As illustrated in FIG. 11(a), a composition 150 for forming a liquid crystal layer which contains a photopolymerizable monomer 151 is injected between a pair of substrates 110 and 120 respectively having alignment films 112 and 122 formed thereon, to produce a conventional liquid crystal display device. Thereafter, the composition 150 is irradiated with ultraviolet light using alight source such as black light so that the photopolymerizable monomer 151 is polymerized. Thereby, photopolymer films 113 and 123 are formed on the alignment films 112 and 122 and a liquid crystal layer 130 is formed, as illustrated in FIG. 11(b). Here, the liquid crystal layer 130 is considered to contain unreacted monomers 152 and polymers 153 (dissolved polymers such as dimers and trimers of the photopolymerizable monomer 151) which have not contributed to formation of the photopolymer films 113 and 123. If a panel provided with such a layer 130 is irradiated with light (especially ultraviolet to blue light) from the backlight while being supplied with a voltage, the unreacted monomers 152 and/or the dissolved polymers 153 are polymerized, that is, the polymerization degree of the unreacted monomers 152 and/or the dissolved polymers 153 increases. As a result, the unreacted monomers 152 and/or the dissolved polymers 153 are eventually phase-separated (cannot remain dissolved in the liquid crystal layer 130) to form an alignment-sustaining layer in addition to the photopolymer films 113 and 123. This results in a change in the pretilt angle, causing “image sticking”. As above, the present inventors have found that the first cause of image sticking is that, after completion of the panel, the light from the backlight progresses polymerization of the unreacted monomers 152 and/or the dissolved polymers 153.

Also, repeating voltage application to the liquid crystal layer 130 after completion of the panel tends to tilt even the liquid crystal molecules near the alignment films 112 and 122 and the photopolymerizable films 113 and 123. This means that the second cause of image sticking can be the weakening of the force to fix the alignment direction of the liquid crystal molecules in the photopolymerizable films 113 and 123, which results in a change in the pretilt angle.

Hence, the present inventors have made further studies and, as a result, have found that a liquid crystal display device having a photopolymer film, formed by polymerizing a photopolymerizable monomer, can achieve the following effects, in the case of containing in the photopolymer film thereof a first monomer unit that has a structure in which three benzene rings are condensed (hereinafter also referred to simply as “three-ring structure”). The effects are that, without changing the conventional production process using the PSA technology, the photopolymer film can absorb (block) ultraviolet to blue light; light from the backlight, particularly ultraviolet to blue light regarded as the main cause of image sticking, can be prevented from reaching the liquid crystal layer; and even if there are unreacted monomers and/or dissolved polymers in the liquid crystal layer, polymerization thereof can be suppressed. The present inventors have also found that the above effects further lead to production of harder photopolymer films and thus to an increase in the force of fixing the alignment of the liquid crystal molecules near the alignment films and/or the photopolymer films, thereby preventing a change in the pretilt angle which is the second cause of image sticking. Those effects have solved the above problems admirably, leading to completion of the present invention.

That is, one aspect of the present invention is a liquid crystal display device (hereinafter also referred to as a “first liquid crystal display device of the present invention”) comprising a pair of substrates, and a liquid crystal layer sandwiched between the pair of substrates, wherein at least one of the pair of substrates has a photopolymer film formed by polymerizing a photopolymerizable monomer, on a surface on the liquid crystal layer side, and the photopolymer film contains a first monomer unit having a structure in which three benzene rings are condensed.

The first liquid crystal display device of the present invention is not particularly limited as long as it includes the above components, and may or may not include other components.

The first liquid crystal display device of the present invention can provide the effect of the present invention even in the case of having a structure in which only one of the substrates has a photopolymer film. Still, a photopolymer film is preferably formed at least on the back-side substrate, and is more preferably formed on both of the substrates.

Preferable embodiments of the first liquid crystal display device of the present invention are described in detail below. Note that the various embodiments below may be appropriately combined. Also, the first liquid crystal display device of the present invention, the later-described second liquid crystal display device of the present invention, and the later-described composition for forming a liquid crystal layer according to the present invention may be appropriately combined.

The structure in which three benzene rings are condensed preferably includes at least one skeleton selected from the group consisting of an anthracene skeleton, a phenanthrene skeleton, and a phenalene skeleton.

In terms of a further increase in the rigidity of the photopolymer film, the structure in which three benzene rings are condensed preferably includes at least an anthracene skeleton, and more preferably is an anthracene skeleton.

In terms of a further increase in the rigidity of the photopolymer film, a first photopolymerizable monomer constituting the first monomer unit preferably has two functional groups directly bonded to the structure in which three benzene rings are condensed.

The two functional groups each preferably have an ethylenic double bond.

The ethylenic double bond is preferably at an end of the first photopolymerizable monomer.

The first photopolymerizable monomer constituting the first monomer unit is preferably represented by formula (I):

P¹−A¹−(Z¹−A²)ₙ−P² (I)

wherein

P¹ and P² each independently represent an acrylate group, a methacrylate group, a vinyl group, a vinyloxy group, an acrylamide group, or a methacrylamide group,

A¹ and A² each independently represent an anthrylene group, a phenanthrylene group, or a phenalenediyl group, each of the groups optionally having a substituent,

Z¹ represents —COO—, —OCO—, or a single bond, and

n represents 0, 1, or 2.

In formula (I), P¹ and P² each independently preferably represent an acrylate group or a methacrylate group, Z¹ represents a single bond, and n represents 0 or 1.

In terms of suppression of coloring of the panel, the photopolymer film is preferably a copolymer further containing a second monomer unit that does not have a structure in which three benzene rings are condensed.

In terms of further suppression of a change in the pretilt angle, the photopolymer film is preferably a homopolymer containing the first monomer unit.

Preferably, at least one of the pair of substrates comprises an alignment film on the photopolymer film on the side opposite to the liquid crystal layer, and more preferably both of the pair of substrates comprise an alignment film on the photopolymer film on the side opposite to the liquid crystal layer.

The alignment film is preferably a vertical alignment film.

The alignment film is preferably a photo-alignment film.

The liquid crystal layer preferably contains nematic liquid crystals with negative dielectric anisotropy.

Another aspect of the present invention is a liquid crystal display device (hereinafter, also referred to as the “second liquid crystal display device of the present invention”) comprising a pair of substrates, and a liquid crystal layer sandwiched between the pair of substrates, wherein at least one of the pair of substrates has a photopolymer film formed by polymerizing a photopolymerizable monomer, on a surface on the liquid crystal layer side, and the photopolymerizable monomer includes a first photopolymerizable monomer having a structure in which three benzene rings are condensed.

The second liquid crystal display device of the present invention is not particularly limited as long as it includes the above components, and may or may not include other components.

The second liquid crystal display device of the present invention can provide the effect of the present invention even in the case of having a structure in which only one of the substrates has a photopolymer film. Still, a photopolymer film is preferably formed at least on the back-side substrate, and is more preferably formed on both of the substrates.

Yet another aspect of the present invention is a composition for forming a liquid crystal layer, for use in formation of a liquid crystal layer sandwiched by a pair of substrates, the composition comprising a first photopolymerizable monomer having a structure in which three benzene rings are condensed.

The structure of the composition for forming a liquid crystal layer according to the present invention is not particularly limited as long as the composition contains the above components, and may or may not contain other components.

Preferable embodiments of the second liquid crystal display device according to the present invention and the composition for forming a liquid crystal layer according to the present invention are described in detail below. Note that the various embodiments below may be appropriately combined.

The structure in which three benzene rings are condensed preferably includes at least one skeleton selected from the group consisting of an anthracene skeleton, a phenanthrene skeleton, and a phenalene skeleton.

In terms of a further increase in the rigidity of the photopolymer film, the structure in which three benzene rings are condensed preferably includes at least an anthracene skeleton, and more preferably is an anthracene skeleton.

In terms of a further increase in the rigidity of the photopolymer film, the first photopolymerizable monomer preferably has two functional groups directly bonded to the structure in which three benzene rings are condensed.

The two functional groups each preferably have an ethylenic double bond.

The ethylenic double bond is preferably at an end of the first photopolymerizable monomer. The first photopolymerizable monomer is preferably represented by the above formula (I).

In formula (I), P¹ and P² each independently preferably represent an acrylate group or a methacrylate group, Z¹ represents a single bond, and n represents 0 or 1.

In terms of suppression of coloring of the panel in the second liquid crystal display device of the present invention, the photopolymerizable monomer preferably further includes a second photopolymerizable monomer that does not have a structure in which three benzene rings are condensed, and the photopolymer film is preferably formed by copolymerizing the photopolymerizable monomer including at least the first photopolymerizable monomer and the second photopolymerizable monomer.

In terms of suppression of coloring of the panel in the composition for forming a liquid crystal layer according to the present invention, the composition for forming a liquid crystal layer preferably further contains a second photopolymerizable monomer that does not have a structure in which three benzene rings are condensed.

In terms of further suppression of a change in the pretilt angle in the second liquid crystal display device of the present invention, the photopolymerizable monomer preferably includes only the first photopolymerizable monomer. In other words, the photopolymer film is preferably formed by polymerizing only the first photopolymerizable monomer.

In terms of further suppression of a change in the pretilt angle in the composition for forming a liquid crystal layer according to the present invention, the composition for forming a liquid crystal layer may contain only the first photopolymerizable monomer as a monomer component.

Preferably, at least one of the pair of substrates comprises an alignment film on the photopolymer film on the side opposite to the liquid crystal layer, and more preferably both of the pair of substrates comprise an alignment film on the photopolymer film on the side opposite to the liquid crystal layer.

The alignment film is preferably a vertical alignment film.

The alignment film is preferably a photo-alignment film.

The liquid crystal layer preferably contains nematic liquid crystals with negative dielectric anisotropy.

### EFFECT OF THE INVENTION

The first and second liquid crystal display devices of the present invention and the composition for forming a liquid crystal layer according to the present invention can sufficiently reduce image sticking without increasing the number of production processes.

### BRIEF DESCRIPTION OF THE DRAWINGS

FIG. 1 is a schematic cross-sectional view illustrating a liquid crystal display device of Embodiment 1.

FIG. 2 is a perspective view showing the relation between the photo-alignment direction and the pretilt direction of the liquid crystal molecules in Embodiment 1.

FIG. 3(a) is a schematic plan view illustrating the average liquid crystal director direction in one dot and the photo-alignment directions for one pair of substrates in the case where the liquid crystal display device of Embodiment 1 employs a mono-domain alignment; and

FIG. 3(b) is a schematic view illustrating the absorption axis directions of polarizers provided in the liquid crystal display device illustrated in FIG. 3(a).

FIG. 4 is a cross-sectional view schematically illustrating a first arrangement of a substrate and a photomask for alignment division by proximity exposure using an alignment mask in the photo-alignment process in Embodiment 1.

FIG. 5 is a cross-sectional view schematically illustrating a second arrangement of a substrate and a photomask for alignment division by proximity exposure using an alignment mask in the photo-alignment process in Embodiment 1.

FIG. 6(a) is a schematic plan view illustrating the average liquid crystal director direction in one dot, the photo-alignment directions for a pair of substrates, and the domain dividing pattern, in the case that the liquid crystal display device of Embodiment 1 employs a four-domain alignment; and

FIG. 6(b) is a schematic view illustrating the absorption axis directions of polarizers provided in the liquid crystal display device illustrated in FIG. 6(a).

FIG. 7(a) is a schematic plan view illustrating the average liquid crystal director direction in one dot, the photo-alignment directions for a pair of substrates, and division patterns of a domain, in the case that the liquid crystal display device of Embodiment 1 employs another four-domain alignment;

FIG. 7(b) is a schematic view illustrating the absorption axis directions of polarizers provided in the liquid crystal display device illustrated in FIG. 7(a); and

FIG. 7(c) is a schematic cross-sectional view along the A-B line in FIG. 7(a) during application of an AC voltage beyond the threshold between the substrates, and illustrates the alignment directions for the liquid crystal molecules.

FIG. 8 is a graph showing the illuminance spectrum of the backlight in Example 1: FIG. 8(a) shows the whole spectrum; and

FIG. 8 (b) is an enlarged view of the graph for the wavelength range of 300 to 450 nm.

FIG. 9 is a graph showing the absorption spectrum of anthracene.

FIG. 10 is a view for describing the effects of the liquid crystal display device of Example 1.

FIG. 11 is a schematic cross-sectional view illustrating a liquid crystal display panel employing the conventional PSA technology: FIG. 11(a) illustrates the state before polymerization of a photopolymerizable monomer; and

FIG. 11(b) illustrates the state after the polymerization of the photopolymerizable monomer.

### MODE(S) FOR CARRYING OUT THE INVENTION

The present invention is described in more detail based on the following embodiments with reference to the drawings. The present invention, however, is not limited to these embodiments.

Photopolymerization herein refers to a polymerization reaction caused by photoirradiation. A photopolymerizable monomer herein refers to a monomer that is polymerized (photopolymerized) by photoirradiation. Here, the term photo or light encompasses not only visible light but also light such as ultraviolet light and infrared light.

An anthracene skeleton, phenanthrene skeleton, or phenalene skeleton herein refers to a structure formed by removing a hydrogen atom from one or more (preferably two or more) carbon atoms in anthracene, phenanthrene, or phenalene.

### Embodiment 1

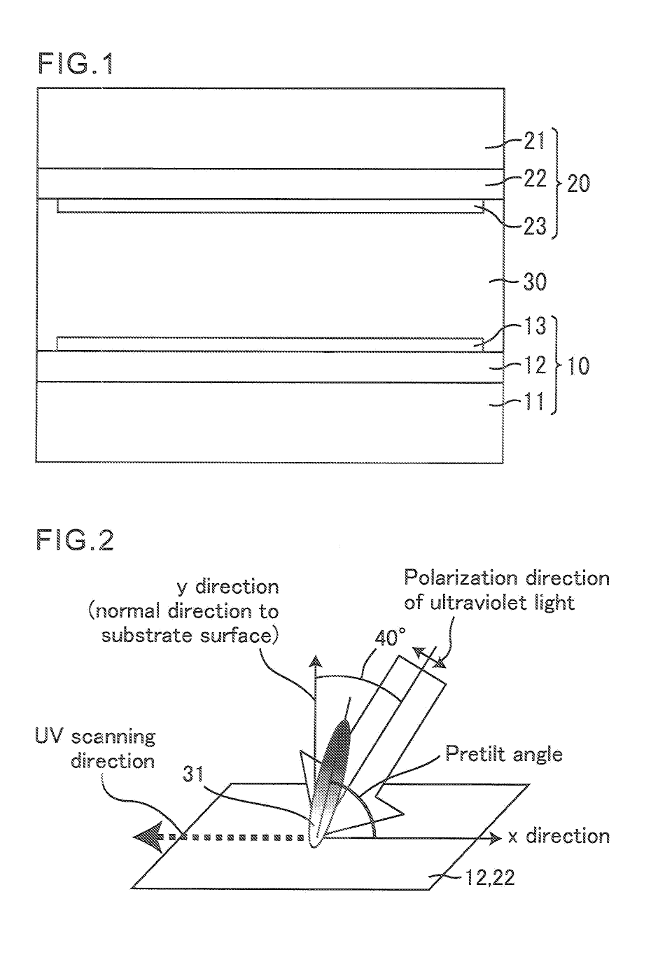

FIG. 1 is a schematic cross-sectional view illustrating a liquid crystal display device of Embodiment 1.

The liquid crystal display device of the present embodiment is, as illustrated in FIG. 1, provided with a pair of substrates 10 and 20, and a liquid crystal layer 30 sandwiched between the pair of substrates 10 and 20. The pair of substrates 10 and 20 has insulating transparent substrates 11 and 21 produced from glass or the like; transparent electrodes (not illustrated) produced from transparent conductive films such as ITO, on the liquid crystal layer 30 sides of the transparent substrates 11 and 21; alignment films 12 and 22 formed on the transparent electrodes; and photopolymer films 13 and 23 formed on the alignment films 12 and 22.

The substrate (lower substrate) 10 is arranged on the backside of the liquid crystal display device, and functions as a driving-element substrate (e.g., TFT substrate) on which a driving element (switching element such as a TFT) is formed in each dot (sub-pixel). The substrate (upper substrate) 20 is arranged on the front side (viewing side) of the liquid crystal display device, and functions as a color filter substrate on which color filters are formed corresponding to the dots on the driving-element substrate. On the substrate 10, the transparent electrodes are arranged in a matrix form, are connected to the driving elements, and function as pixel electrodes. On the substrate 20, meanwhile, the transparent electrode is arranged seamlessly over the entire surface of the display region, and functions as a counter electrode (common electrode).

The liquid crystal display device of the present embodiment is not particularly limited to a color liquid crystal display device, and may be a monochrome liquid crystal display device in which case no color filter is required on the substrate 20. Also in this case, a dot in the description of the present embodiment can be read as a pixel.

Each of the substrates 10 and 20 has a polarizer (not illustrated) on a face thereof on the side opposite to the liquid crystal layer 30, and the polarizers are arranged in crossed Nicols. The pair of substrates 10 and 20 has, at a predetermined position (light shielding region) therebetween, a cell-thickness retainer (spacer, not illustrated) for retaining a uniform thickness (e.g., 2.0 to 10.0 μm) of the cell. The substrate 10 also has a backlight (not illustrated) as a light source, on the backside thereof.

The photopolymer films 13 and 23 each have a function to maintain (fix) the alignment direction (initial alignment, pretilt) of the liquid crystal molecules which is set by the alignment films 12 and 22. The photopolymer films 13 and 23 are formed on the liquid crystal layer 30 side surface of the alignment films 12 and 22 by polymerizing a photopolymerizable monomer which is polymerized by photopolymerization. More specifically, the photopolymer films 13 and 23 are formed by injecting a composition for forming a liquid crystal layer, prepared by adding a photopolymerizable monomer to a liquid crystal material, between the pair of substrates 10 and 20 (empty cell); and irradiating the cell with light (preferably ultraviolet light) from the substrate 10 side such that the photopolymerizable monomer is polymerized. In this way, the liquid crystal display device of the present embodiment is produced using the PSA technology. The composition for forming a liquid crystal layer may further contain a photopolymerization initiator.

The photopolymer films 13 and 23 are formed using a photopolymerizable monomer which has a condensed ring structure in the main chain thereof. As a result, ordinary liquid crystal molecules without a functional group and photopolymerizable monomer molecules are oriented to the same direction, which enables fixation of the alignment direction of the liquid crystal molecules.

The photopolymer films 13 and 23 each contain a first monomer unit having a structure (three ring structure) in which three benzene rings are condensed, such as anthracene, phenanthrene, and phenalene. This means that the photopolymer films 13 and 23 are formed using a composition for forming a liquid crystal layer which contains a first photopolymerizable monomer having a three ring structure.

The photopolymer films 13 and 23 produced thereby can selectively absorb light in the short-wavelength range, specifically ultraviolet to blue light, and more specifically light with a wavelength in the range of 300 nm to 400 nm. For this reason, the photopolymer films 13 and 23 can absorb light emitted from the backlight, particularly ultraviolet to blue light which is considered to be the main cause of image sticking, thereby preventing the light with such a wavelength from reaching the liquid crystal layer 30. As a result, even in the case that unreacted monomers and/or dissolved polymers are in the liquid crystal layer 30, polymerization of those compounds, i.e., the first cause of image sticking, can be suppressed.

Those photopolymer films 13 and 23 have higher rigidity than a photopolymer film that contains only a photopolymerizable monomer having a two-ring structure and/or a photopolymerizable monomer not having a condensed ring structure as in the case of the monomer described in Patent Document 1. The alignment films 12 and 22 and/or the photopolymer films 13 and 23 therefore can provide larger force to fix the alignment of the liquid crystal molecules near these films. As a result, a change in the pretilt angle, which is the second cause of image sticking, can be suppressed.

Further, the liquid crystal display device of the present embodiment can be produced through the conventional production processes for a liquid crystal display device using the PSA technology, and therefore the number of the production processes is not increased.

The irradiation conditions in the photoirradiation process for forming the photopolymer films 13 and 23 are not particularly limited, and can be set to the same as those for the conventional PSA technology. More specifically, light with a peak wavelength of 300 to 350 nm (ultraviolet light) is preferably irradiated for five minutes or more.

The ultraviolet light emitted by the backlight, since being weak can be blocked, as described above, with absorption by a three-ring structure such as anthracene. In contrast, black light, which is usually used as a light source for polymerization of a photopolymerizable monomer, has high ultraviolet light intensity, and therefore can progress polymerization of a photopolymerizable monomer without being absorbed by a three-ring structure even under conventional irradiation conditions. To avoid absorption by a three-ring structure, light with a short wavelength and light with a long wavelength, which are not absorbed by a three-ring structure, can be used for polymerization of a photopolymerizable monomer. However, use of light with a short wavelength increases the possibility of decomposition degradation of the material, and use of light with a long wavelength lengthens the polymerization time.

The three-ring structure is not particularly limited, and an anthracene skeleton, a phenanthrene skeleton, and/or a phenalene skeleton are preferable. Particularly, an anthracene skeleton is preferable as the three-ring structure because photodimerization occurs at the anthracene skeleton portion, which further increases the rigidity of the photopolymer films 13 and 23.

The first photopolymerizable monomer constituting the first monomer unit preferably has two functional groups directly bonded to the three-ring structure. As above, the first photopolymerizable monomer preferably has two functional groups directly bonded to the three-ring structure. Such a structure further increases the rigidity of the photopolymer films 13 and 23. If the photopolymer films 13 and 23 each have a flexible moiety such as an alkylene group and a polymethylene group between a three-ring structure and a functional group, application of a voltage to the liquid crystal display device after polymerization leads to deformation of the polymers as well as the liquid crystal molecules, which may cause image sticking.

The two functional groups are not particularly limited as long as they are photopolymerizable functional groups. Still, the functional groups each preferably have an ethylenic unsaturated group, particularly an ethylenic double bond.

The position of the bond of the-three ring structure with the two functional groups is not particularly limited. The ethylenic double bond (ethylenic unsaturated group) is preferably at an end of the first photopolymerizable monomer.

A photopolymerizable monomer represented by formula (I) is suitable as the first photopolymerizable monomer constituting the first monomer unit. Particularly, it is preferable in formula (I) that P¹ and P² each independently represent an acrylate group or a methacrylate group, Z¹ represent a single bond, and n represent 0 or 1. In terms of increasing the rigidity of the photopolymer films 13 and 23, it is preferable that A¹ and A² each independently represent an anthrylene group.

In formula (I), each of the anthrylene group, the phenanthrylene group, and the phenalenediyl group may have a substituent such as an alkyl group (e.g., methyl) and a halogen in addition to having two functional groups. Still, each of those preferably does not have a substituent other than the two functional groups.

In formula (I), the position of the bond of an anthrylene group, a phenanthrylene group, or a phenalenediyl group with P¹ and P² is not particularly limited, and may be appropriately set.

More specifically, examples of the first photopolymerizable monomer include a monomer having an acrylate group represented by the following formula (1), a monomer having a methacrylate group represented by the following formula (2), a monomer having an acrylamide group represented by the following formula (3), a monomer having a methacrylamide group represented by the following formula (4), a monomer having a vinyloxy group represented by the following formula (5), and a monomer having a vinyl group represented by the following formula (6). In formulas (1) to (6), A represents an anthrylene group, a phenanthrylene group, or a phenalenediyl group, and the position of the bond of the anthrylene group, the phenanthrylene group, or the phenalenediyl group with the functional groups is not particularly limited. Each of the anthrylene group, the phenanthrylene group, and the phenalenediyl group in formulas (1) to (6) may have a substituent such as an alkyl group (e.g. methyl) and a halogen in addition to having two functional groups, but preferably does not have a substituent other than the two functional groups. Each of these monomers has two functional groups directly bonded to an anthrylene group, a phenanthrylene group, or a phenalenediyl group, and the two functional groups each have an ethylenic double bond at an end of the monomer.

[symbol]

The photopolymer films 13 and 23 each may be a copolymer further containing a second monomer unit that does not have a three-ring structure. This structure enables to suppress blue coloring of the panel even in the case that an anthracene skeleton is employed as the three-ring structure. Alternatively, the photopolymer films 13 and 23 each may be a homopolymer containing the first monomer unit. This structure enables further absorption of the light emitted from the backlight, particularly the ultraviolet to blue light which is considered to be the main cause of image sticking. In this way, the composition for forming a liquid crystal layer may further contain as a monomer component a second photopolymerizable monomer that does not have a three ring structure, or may contain only a first photopolymerizable monomer.

The second photopolymerizable monomer constituting the second monomer unit is not particularly limited, and may be any monomer used in the conventional PSA technology. Specific examples thereof include the monomers mentioned in Patent Document 1. In the case that the photopolymer films 13 and 23 each are a copolymer, arrangement of the monomer units is not particularly limited. That is, the photopolymer films 13 and 23 each may be any type of copolymer of an alternating copolymer, a block copolymer, a random copolymer, and a graft copolymer.

The molecular weight of each of the photopolymer films 13 and 23 is not particularly limited as long as it is about the same as that of a photopolymer film used in the conventional PSA technology.

The proportion of the photopolymerizable monomer (the first photopolymerizable monomer and/or the second photopolymerizable monomer) in the composition for forming a liquid crystal layer is not particularly limited. The proportion may be set to a value that is about the same as the proportion in a composition for forming a liquid crystal layer for the conventional PSA technology, which is, specifically, about 0.01 to 10% by weight (more preferably 0.1 to 1% by weight).

The liquid crystal layer 30 preferably contains liquid crystal molecules (nematic liquid crystals) with negative dielectric anisotropy Δε. More specifically, Δε is preferably 0.2 to 10, and Δn of the liquid crystal layer 30 is preferably 0.02 to 0.3.

The alignment process for the alignment films 12 and 22 is not particularly limited, and is preferably photo-alignment (more preferably alignment using untraviolet light, and still more preferably alignment using polarized ultraviolet light). In this way, the alignment films 12 and 22 each are preferably a photo-alignment film. The material for a photo-alignment film is not particularly limited, and may be of an optical-coupling type or a photodegradation type. For example, a known material such as a polyimide material and a polyamide acid material can be used. Specific examples of the optical-coupling type material include polyimides having a photosensitive group such as 4-chalcone, 4′-chalcone, coumarin, cinnamoyl, and cinnamate. Specific examples of the photodegradation type material include RN722, RN783, and RN784 produced by Nissan Chemical Industries, Ltd., and JALS-204 produced by JSR. The thickness of a photo-alignment film and the conditions of the alignment process are not particularly limited, and can be appropriately set according to the material used.

The pretilt angle that the alignment films 12 and 22 give is not particularly limited. The alignment films 12 and 22 preferably align the liquid crystal molecules substantially vertically. More specifically, the pretilt angle of the liquid crystal layer 30 is preferably 80° to 90° (more preferably 85° to 90°). In this way, the alignment films 12 and 22 each are preferably a vertical alignment film. The material of a vertical alignment film is not particularly limited, and may be a known one. The thickness of a vertical alignment film and the conditions of the alignment process can also be appropriately set.

The liquid crystal display device of the present embodiment suitably functions in the RTN (Reverse Twisted Nematic) mode in which the respective alignment directions for a pair of substrates are perpendicular to each other, particularly in a mode in which one dot is divided into four domains (4D-RTN mode). The 4D-RTN mode excellently improves the viewing angle, but requires highly precise control of the pretilt. In this regard, since the liquid crystal display device of the present embodiment provides a highly stable pretilt, the liquid crystal display device can achieve sufficient alignment stability even with the 4D-RTN mode, and therefore provides a preferable wide viewing angle. As above, the concept of the present invention is suitably applied to the technology of making a photopolymer film memorize (sustain) the aligned state achieved in advance by photo-alignment, while no voltage is applied to the liquid crystal layer. The concept of the present invention is particularly suitably applied to a technology that employs the 4D-RTN mode in combination with the PSA technology.

In terms of achievement of the 4D-RTN mode with excellent display qualities, the alignment films 12 and 22 each are preferably a vertical alignment film which is preferably produced by photo-alignment (more preferably alignment using ultraviolet light and still more preferably alignment using polarized ultraviolet light). That is, the alignment films 12 and 22 each are preferably a vertical photo-alignment film.

In the following, a case will be more specifically described in which the liquid crystal display device of the present embodiment is in the RTN mode.

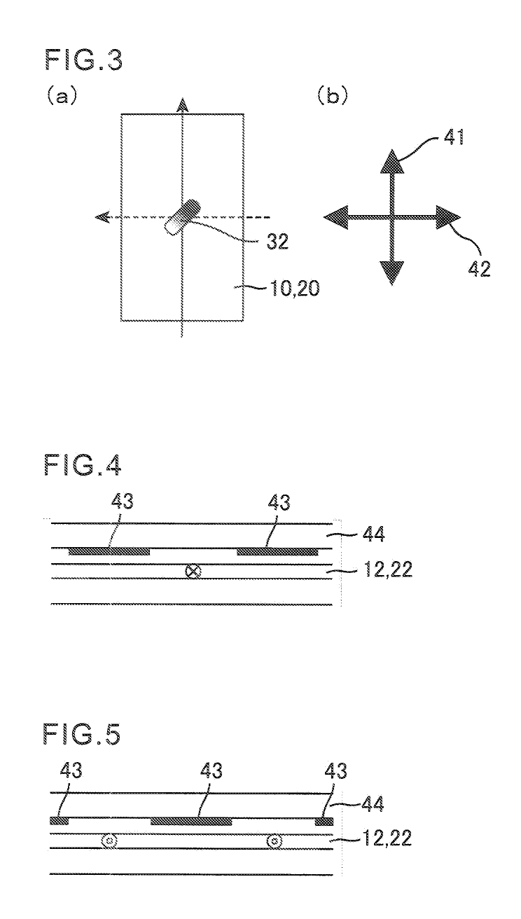

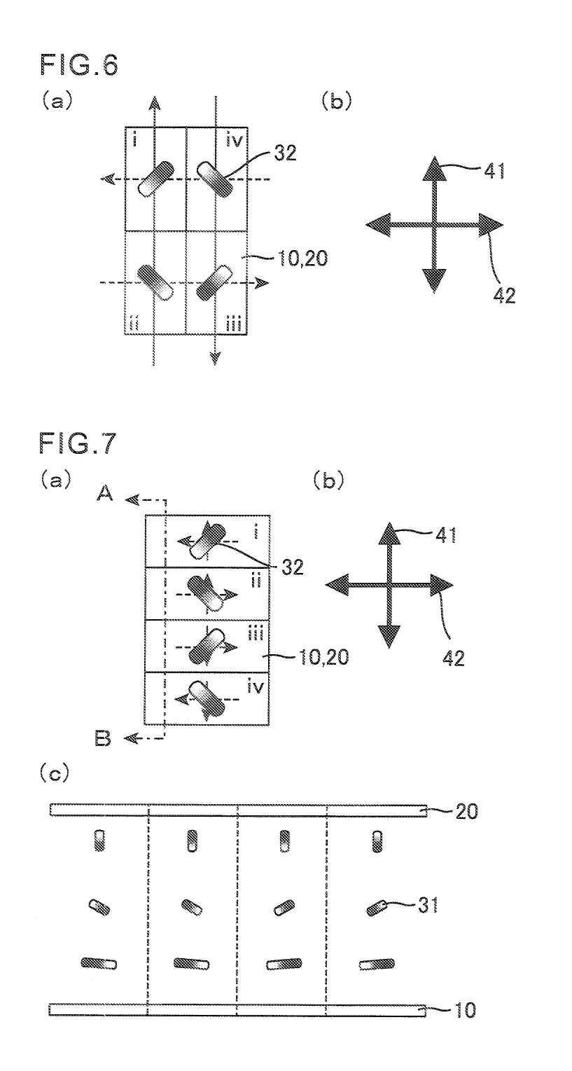

FIG. 2 is a perspective view schematically showing the relation between the photo-alignment direction and the pretilt direction of the liquid crystal molecules in Embodiment 1. FIG. 3(a) is a schematic plan view illustrating the average liquid crystal director direction in one dot and the photo-alignment directions for one pair of substrates in the case where the liquid crystal display device of Embodiment 1 employs a mono-domain alignment; and FIG. 3(b) is a schematic view illustrating the absorption axis directions of polarizers provided in the liquid crystal display device illustrated in FIG. 3(a). Here, FIG. 3(a) illustrates the state where the respective photo-alignment directions for the substrates are perpendicular to each other, and an AC voltage larger than the threshold is applied between the substrates. In FIG. 3(a), the solid arrow indicates the photoirradiation direction (photo-alignment direction) for a driving-element substrate, and the dashed arrow indicates the photoirradiation direction (photo-alignment direction) for a color filter substrate. FIG. 4 is a cross-sectional view schematically illustrating a first arrangement of a substrate and a photomask for alignment division by proximity exposure using an alignment mask in the photo-alignment process in Embodiment 1. FIG. 5 is a cross-sectional view schematically illustrating a second arrangement of a substrate and a photomask for alignment division by proximity exposure using an alignment mask in the photo-alignment process in Embodiment 1. FIG. 6(a) is a schematic plan view illustrating the average liquid crystal director direction in one dot, the photo-alignment directions for a pair of substrates, and the domain dividing pattern, in the case that the liquid crystal display device of Embodiment 1 employs a four-domain alignment; and FIG. 6(b) is a schematic view illustrating the absorption axis directions of polarizers provided in the liquid crystal display device illustrated in FIG. 6(a). Here, FIG. 6(a) illustrates the state where an AC voltage larger than the threshold is applied between the pair of substrates. In FIG. 6(a), the solid arrow indicates the photoirradiation direction (photo-alignment direction) for a driving-element substrate, and the dashed arrow indicates the photoirradiation direction (photo-alignment direction) for a color filter substrate.

In the case that the liquid crystal display device of the present embodiment employs the RTN mode, the liquid crystal layer 30 sandwiched between the pair of substrates 10 and 20 contains liquid crystal molecules with negative dielectric anisotropy. The alignment films 12 and 22 each are a photo-alignment film (vertical photo-alignment film) providing vertical alignment.

Upon being irradiated with ultraviolet light (white arrow in FIG. 2), which has been polarized in parallel with the plane of incidence, at an angle of, for example, 40° from the normal direction to the substrate surface as illustrated in FIG. 2, the alignment films 12 and 22 give the liquid crystal molecule 31 a pretilt angle in the UV irradiation direction. Here, the exposure of the alignment films 12 and 22 may be one-shot exposure or scanning exposure. That is, the alignment films 12 and 22 may be irradiated with light, with the substrates and the light source being fixed. Alternatively, the alignment films 12 and 22 may be irradiated with UV light scanning along the UV scanning direction as shown by the dashed arrow in FIG. 2. The RTN-mode liquid crystal display device of the present embodiment is formed by exposing the alignment films and attaching the substrates in such a manner that, as illustrated in FIG. 3(a), the respective photoirradiation directions for the substrates 10 and 20 are substantially perpendicular to each other in a plan view of the substrates. Further, the pretilt angles are substantially the same for liquid crystal molecules near the alignment films 12 and 22 respectively formed on the substrates 10 and 20, and a liquid crystal material containing no chiral material is injected into the liquid crystal layer 30. In this case, application of an AC voltage larger than the threshold between the substrates 10 and 20 gives a 90° twist to the liquid crystal molecules in the normal direction to the substrate surface between the substrates 10 and 20. Also, FIG. 3(a) indicates that the average liquid crystal director direction 32 during the application of an AC voltage appears to be on a line that halves an angle formed by the photoirradiation directions for the respective substrates 10 and 20 in a plan view of the substrates 10 and 20. FIG. 3(b) indicates that the absorption axis direction 42 of the polarizer (upper polarizer) arranged on the color filter substrate side is the same as the photo-alignment direction for the color filter substrate. Also, the absorption axis direction 41 of the polarizer (lower polarizer) arranged on the driving-element substrate side is the same as the photo-alignment direction for the driving-element substrate.

Next, a case will be described in which each dot in the RTN-mode liquid crystal display device according to the present embodiment is in a multi-domain alignment. In the exposure process for forming four domains, exposure is performed using a photomask 44 that has light-shielding portions 43 each having a size of the half of one dot so that the regions each corresponding to the half of one dot is exposed in one direction (in FIG. 4, from the side drawn in the figure to the depth), and the other halves of the regions are shielded from light by the light-shielding portions 43. Next, as illustrated in FIG. 5, the photomask 44 is shifted by a distance equal to about half of a dot pitch so that the exposed regions are shielded by the light-shielding portions 43 and the regions which have not been exposed (the unexposed regions in the process described using FIG. 4) are exposed in the reverse direction (in FIG. 5, from the depth to the side drawn in the figure). Thereby, the regions, giving the pretilt angles for liquid crystals in the opposite directions from each other, are alternately formed in a stripe arrangement in such a manner that each dot is divided into two regions in the liquid crystal display device.

In this way, each dot is provided with a multi-domain alignment to halve each dot in the substrates 10 and 20 at equal pitches. Then, the substrates 10 and 20 are arranged (attached) such that the alignment division directions (photo-alignment directions) for the substrates 10 and 20 are perpendicular to each other in a plan view of the substrates, and a liquid crystal material containing no chiral material is injected into the liquid crystal layer 30. Thereby, the four-domain alignment illustrated in FIG. 6(a) can be provided in which the alignment directions of the liquid crystal molecules near the center of the liquid crystal layer 30 in the thickness direction are different from each other in the four regions i to iv in FIG. 6(a), i.e., they are substantially perpendicular to each other. That is, as illustrated in FIG. 6(a), the average liquid crystal director direction 32 during the application of an AC voltage appears to be on a line that halves an angle formed by the photoirradiation directions for the respective substrates 10 and 20 in each domain in a plan view of the substrates 10 and 20. FIG. 6(b) indicates that the photo-alignment direction (in FIG. 6(a), dashed arrows) for the color filter substrate is the same as the absorption axis direction 42 of the upper polarizer, and the photo-alignment direction (in FIG. 6(a), solid arrows) for the driving-element substrate is the same as the absorption axis direction 41 of the lower polarizer, in a plan view of the substrates 10 and 20.

The domains in the RTN mode may be in any layout other than the four-domain layout illustrated in FIG. 6(a), and may be in the layout illustrated in FIG. 7(a). FIG. 7(a) is a schematic plan view illustrating the average liquid crystal director direction in one dot, the photo-alignment directions for a pair of substrates, and division patterns of a domain, in the case that the liquid crystal display device of Embodiment 1 employs another four-domain alignment; FIG. 7(b) is a schematic view illustrating the absorption axis directions of polarizers provided in the liquid crystal display device illustrated in FIG. 7(a); and FIG. 7(c) is a schematic cross-sectional view along the A-B line in FIG. 7(a) during application of an AC voltage beyond the threshold between the substrates, and illustrates the alignment directions for the liquid crystal molecules. In FIG. 7(a), the solid arrows indicate the photoirradiation directions (photo-alignment directions) for the driving-element substrate, and the dashed arrows indicate the photoirradiation directions (photo-alignment directions) for the color filter substrate. Also, in FIG. 7(c), the dashed line indicates domain borders.

To provide such alignment, each dot is first provided with multi-domain alignment to halve each dot in the substrates 10 and 20 at equal pitches as illustrated in FIG. 7(a). Then, the substrates 10 and 20 are arranged (attached) such that the alignment division directions (photo-alignment directions) for the substrates 10 and 20 are perpendicular to each other and the color filter substrate is off the original position by a distance of about ¼ of the dot pitch in the direction of the solid arrow in FIG. 7(a). Thereby, the four-domain structure illustrated in FIG. 7(a) can be formed in which the alignment directions of the liquid crystal molecules near the center of the liquid crystal layer 30 in the thickness direction are different from each other in the four regions i to iv in FIG. 7(a), i.e., they are substantially perpendicular to each other. That is, as illustrated in FIG. 7(a), the average liquid crystal director direction 32 during the application of an AC voltage appears to be on a line that halves an angle formed by the photoirradiation directions for the respective substrates 10 and 20 in each dot in a plan view of the substrates 10 and 20. FIG. 7(b) indicates that, in this alignment, the photo-alignment directions (in FIG. 7(a), dashed arrows) for the color filter substrate are the same as the absorption axis direction 42 of the upper polarizer, and photo-alignment directions (in FIG. 7(a), solid arrows) for the driving-element substrate are the same as the absorption axis direction 41 of the lower polarizer, in a plan view of the substrates 10 and 20. The liquid crystal molecules are aligned in the direction perpendicular to the substrates 10 and 20 due to the alignment force of the alignment films 12 and 22 when no voltage is applied between the substrates 10 and 20. The liquid crystal molecules 31 are, in contrast, twisted about 90° between the substrates 10 and 20 when a voltage larger than the threshold is applied between the substrates 10 and 20 as illustrated in FIG. 7(c), and four different alignment patterns are used for the respective four domains.

### Synthesis Example 1

One example of synthesis of a first photopolymerizable monomer having a three-ring structure is described below.

Firstly, to a benzene (20 mL) solution containing 0.5 g (2.5 mM) of 9,10-diaminophenanthrene represented by the following formula (7) and 1 g (10 mM) of triethylamine, abenzene solution (5 mL) containing 0.5 g (5 mM) of methacrylic acid chloride represented by the following formula (8) was dropped at room temperature in nitrogen atmosphere. Then, the solution was reacted at room temperature for two hours. After completion of the reaction, the impurities were extracted with water, and the solution was purified by column chromatography (toluene/ethyl acetate=( 4/1)), whereby 0.55 g (yield: 64%) of the target compound (monomer) represented by the following formula (9) was obtained.

[symbol]

### Synthesis Example 2

Another example of synthesis of a first photopolymerizable monomer having a three-ring structure is described below.

Firstly, to a benzene (20 mL) solution containing 0.5 g (2.4 mM) of 1,9-dihydroxyphenanthrene represented by the following formula (10) and 1 g (10 mM) of triethylamine, a benzene solution (5 mL) containing 0.5 g (5 mM) of methacrylic acid chloride represented by the following formula (11) was dropped at room temperature in nitrogen atmosphere. Then, the solution was reacted at room temperature for two hours. After completion of the reaction, the impurities were extracted with water, and the solution was purified by column chromatography (toluene/ethyl acetate=( 4/1)), whereby 0.63 g (yield: 76%) of the target compound (monomer) represented by the following formula (12) was obtained.

[symbol]

An actual production example of the 4D-RTN liquid crystal display device according to the present invention using the 4D-RTN technology is described below.

### Example 1

An active matrix substrate and a color filter substrate were produced as the pair of substrates of the present Example. The active matrix substrate had TFTs, source wirings, gate wirings, and storage capacitor wirings on a glass substrate, and further had pixel electrodes on those components with an insulating film arranged therebetween. The color filter substrate had RGB color filters on a glass substrate, and further had a common electrode thereon.

On each of the substrates was formed a polyamic acid photo-alignment film (imidization rate: about 50%) with a cinnamate group on a side chain, and the substrates were pre-baked at 90° C. and then baked at 200° C.

The alignment process was then performed in which the photo-alignment films were irradiated with P-polarized ultraviolet light (light with a peak wavelength of 270 to 360 nm) from an oblique direction (direction at an angle of 40° to 50° from the substrate surface). The process enables to form a vertical alignment film (vertical photo-alignment film) with a pretilt angle of about 88.1°. Here, the irradiation energy for the alignment treatment can be set within the range of 10 mJ/cm² to 1 J/cm² (preferably 50 mJ/cm² to 200 mJ/cm²), and was 100 mJ/cm² in the present Example. The alignment process was performed such that the domains in the matrix arrangement illustrated in FIG. 6 were formed.

A sealing material was applied to one of the substrates and beads (spacer) were spread on the other of the substrates. The substrates were attached to each other, and therebetween a composition for forming a liquid crystal layer, containing nematic liquid crystals with negative dielectric anisotropy, was injected.

The composition for forming a liquid crystal layer contained 0.6% by weight (relative to the liquid crystals) of a mixture of monomers prepared by adding 10% by weight of a bifunctional monomer (first photopolymerizable monomer, represented by the following formula (14)) having an anthracene structure (structure in which three benzene rings are bonded) at the core to the bifunctional monomer (second photopolymerizable monomer) represented by following formula (13). After the injection of the composition, the cell was heated at 130° C., quenched, and irradiated with black light (ultraviolet light with a peak wavelength of 300 to 350 nm) for five minutes or more, so that the monomers were polymerized.

[symbol]

On each side of the liquid crystal cell produced thereby, components such as a phase plate and a polarizer were provided, and a backlight was provided on the side opposite to the display side of the liquid crystal display panel, whereby the liquid crystal display device of Example 1 was produced.

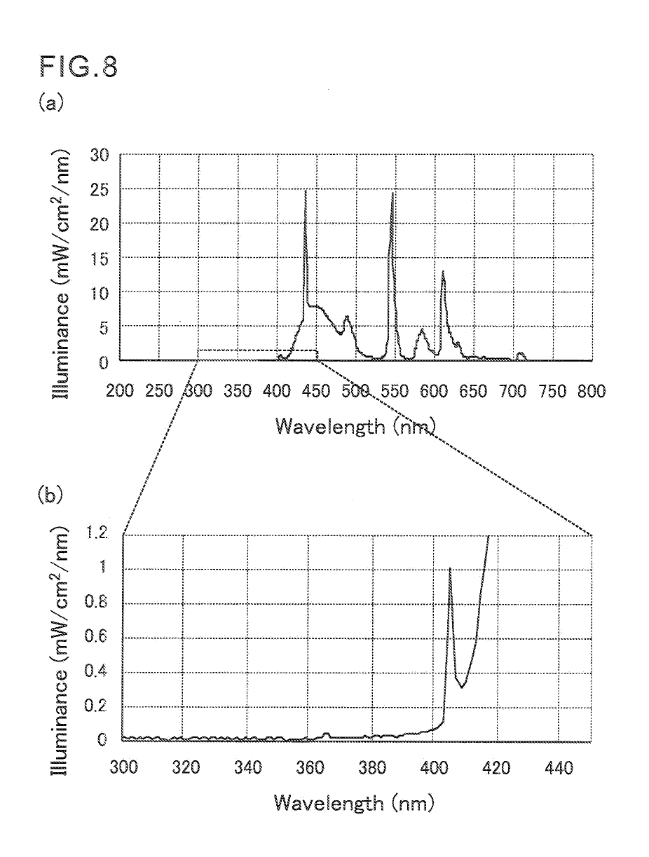

FIG. 8 is a graph showing the illuminance spectrum of the backlight in Example 1: FIG. 8(a) shows the whole spectrum; and FIG. 8(b) is an enlarged view of the graph for the wavelength range of 300 to 450 nm.

FIG. 8 shows that the backlight used in the present Example emitted a small amount of light with a wavelength of about 300 to 400 nm.

Now, the effect of the liquid crystal display device of the present Example will be described. The liquid crystal display device of the present Example can block ultraviolet to blue light, and can more firmly fix the tilt of the liquid crystal molecules on the surface of the photo-alignment films.

First, blocking of the ultraviolet to blue light is described. Generally, the cause of the image sticking on a 4D-RTN panel is considered to be that the panel, while being supplied with a voltage, is irradiated with light having a wavelength of 300 to 400 nm which is emitted from the backlight.

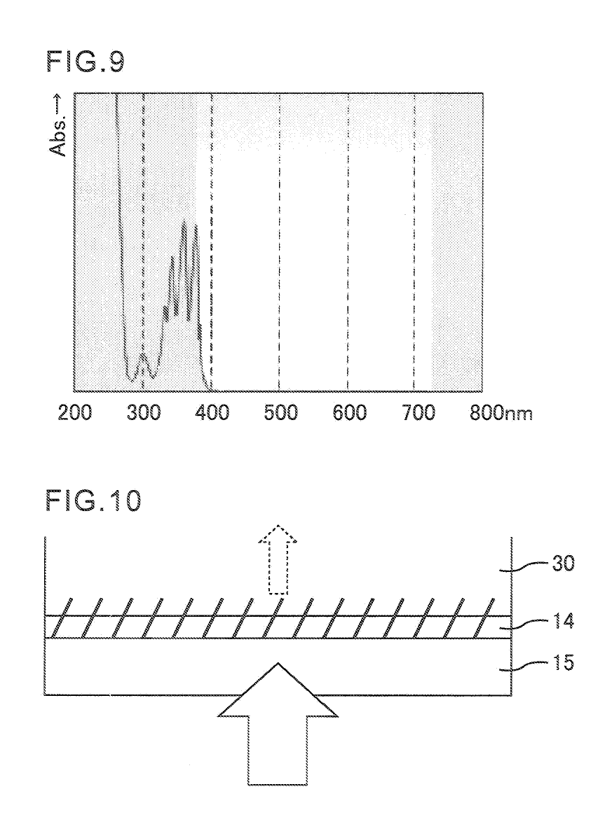

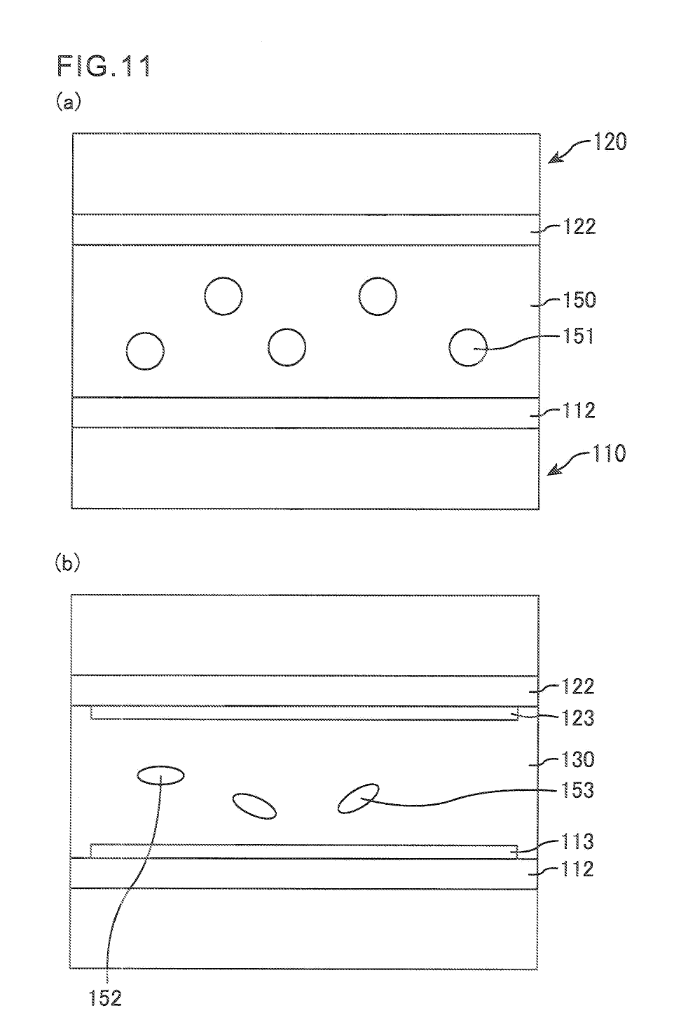

Meanwhile, if a molecule, having a structure in which multiple benzene rings are bonded (condensation structure), has a larger number of benzene rings, the absorption spectrum of light is more shifted to the long wavelength side. If the number of benzene rings bonded is three as in the following formula (15), the absorption by the molecule appears in the wavelength range of 300 to 400 nm as shown in FIG. 9 (the black line in FIG. 9). Examples of the molecule having a structure in which three benzene rings are bonded include anthracene.

[symbol]

Further, absorption wavelength of an organic molecule changes according to its molecular structure in many cases, and the absorption wavelength of a molecule having an anthracene structure represented by formula (14) at the core is almost the same as that of anthracene.

The monomer represented by formula (14) also functions as a monomer for the PSA technology. Hence, PSA polymerization of the composition for forming a liquid crystal layer, containing the monomer represented by formula (14), enables formation of PSA polymerization films 14 (photopolymer films 13 and 23) which are capable of absorbing light with a wavelength of 300 to 400 nm, on vertical photo-alignment films 15 (alignment films 12 and 22). The PSA polymer films 14 therefore can absorb light (white arrow in FIG. 10) with a wavelength of 300 to 400 nm included in the light from the backlight, shielding the liquid crystal layer 30 from the light with such a wavelength. As a result, it is possible to suppress the progress of the presumed cause of image sticking, i.e., the polymerization of the unreacted monomers and/or dissolved polymers in the liquid crystal layer 30.

Next, fixation enforcement of the tilt of the liquid crystal molecules on the alignment film surface will be described. Monomers having a benzene ring on a side chain generally form a polymer with high hardness, and a larger number of the bonded benzene rings leads to higher hardness of the polymer.

In the present Example, a monomer represented by formula (14), which has a structure in which three benzene rings are bonded, is added to a monomer represented by formula (13) having been conventionally used. This makes it possible to form the PSA polymer films 14 that are more rigid than conventional PSA polymer films. Therefore, the tilt of the liquid crystal molecules (slant bars in FIG. 10) on the surface of the vertical photo-alignment films 15 and/or the PSA polymer films 14 can be fixed more firmly. As a result, a change in the tilt, another presumed cause of image sticking, can be suppressed.

### Example 2

The liquid crystal display device of Example 2 was produced through the same processes as those in Example 1, except that the monomer added to the composition for forming a liquid crystal layer included only the first photopolymerizable monomer represented by formula (14). That is, the composition for forming a liquid crystal layer did not contain the second photopolymerizable monomer represented by formula (13), and contained only the first photopolymerizable monomer represented by formula (14) in an amount of 0.6% by weight relative to the liquid crystals.

In the case that the monomer for PSA being added to the liquid crystal material is only a monomer that absorbs light with a wavelength of 300 to 400 nm represented by formula (14), the two effects of blocking ultraviolet to blue light and enforcing the fixation of the tilt of liquid crystal molecules on the alignment film surface can be achieved in a more marked way.

### Comparative Example 1

The liquid crystal display device of Comparative Example 1 was produced through the same processes as those in Example 1, except that the monomer added to the composition for forming a liquid crystal layer included only the second photopolymerizable monomer represented by formula (13). That is, the composition for forming a liquid crystal layer did not contain the first photopolymerizable monomer represented by formula (14), and contained only the second photopolymerizable monomer represented by formula (13) in an amount of 0.6% by weight relative to the liquid crystals.

### Measurement of Change in Pretilt Angle

Each of the liquid crystal display devices of Examples 1 and 2 and Comparative Example 1 was irradiated with light from the backlight for 100 hours while being supplied with a voltage of 10 V (30 Hz), and a change in the pretilt angle before and after the irradiation was measured. Table 1 shows the measurement results. Here, the pretilt angle was measured using a commercially available tilt angle measuring device.

TABLE 1

| | | Change in |
|---|---|---|
| | Monomer | pretilt angle (°) |
| Example 1 | Formula (13):formula (14) = 9:1 | 0.51 |
| Example 2 | Formula (14) only | 0.32 |
| Comparative Example 1 | Formula (13) only | 0.88 |

The results show that the change in the pretilt angle in Example 1 was smaller than in Comparative Example 1. This is probably because, in Example 1, the monomer absorbing light with a wavelength of 300 nm to 400 nm (represented by formula (14)) added to the monomer represented by formula (13) enabled formation of a PSA polymer film that blocks the light from the backlight illustrated in FIG. 8, particularly the light with a wavelength of about 300 to 400 nm which is considered to change the tilt.

In contrast, no monomer absorbing light in the wavelength of 300 nm to 400 nm (represented by formula (14)) was used in Comparative Example 1. Therefore, the light with a wavelength of about 300 nm to 400 nm included in the light from the backlight was not blocked, which largely changed the pretilt angle and thus led to image sticking.

The above results therefore show that a composition for forming a liquid crystal layer can contribute to reduction of image sticking in the case of containing a small amount of a monomer that absorbs light with a wavelength of 300 nm to 400 nm.

Meanwhile, the change in the pretilt angle in Example 2 was even smaller than in Example 1. As above, in case that the monomer for PSA includes only a monomer that absorbs light in the wavelength of 300 to 400 nm represented by formula (14), the change in the pretilt angle was found to be more suppressed than in Example 1 in which the monomer represented by formula (13) and the monomer represented by formula (14) were mixed.

Still, since the fluorescence of anthracene is in the wavelength range of 350 to 500 nm, use of only the monomer represented by formula (14) may possibly cause slight blue coloring of the panel. The monomer having a condensation structure with three benzene rings, such as the monomer represented by formula (14), is added preferably in an amount that does not case coloring of the panel.

The present application claims priority to Patent Application No. 2009-3821 filed in Japan on Jan. 9, 2009 under the Paris Convention and provisions of national law in a designated State, the entire contents of which are hereby incorporated by reference.

### EXPLANATION OF SYMBOLS

10, 20: Substrate

11, 21: Transparent substrate

12, 22: Alignment film

13, 23: Photopolymer film

14: PSA polymer film

15: Vertical photo-alignment film

30: Liquid crystal layer

31: Liquid crystal molecule

32: Liquid crystal director direction

41: Absorption axis direction of lower polarizer

42: Absorption axis direction of upper polarizer

43: Light-shielding portion

44: Photomask

150: Composition for forming liquid crystal layer

151: Photopolymerizable monomer

152: Unreacted monomer

153: Dissolved polymer

1. A liquid crystal display device comprising
a pair of substrates, and
a liquid crystal layer sandwiched between the pair of substrates, wherein
at least one of the pair of substrates has a photopolymer film formed by polymerizing a photopolymerizable monomer, on a surface on the liquid crystal layer side, and
the photopolymer film contains a first monomer unit having a structure in which three benzene rings are condensed.

2. The liquid crystal display device according to claim 1, wherein
the structure in which three benzene rings are condensed includes at least one skeleton selected from the group consisting of an anthracene skeleton, a phenanthrene skeleton, and a phenalene skeleton.

3. The liquid crystal display device according to claim 1, wherein
the structure in which three benzene rings are condensed includes at least an anthracene skeleton.

4. The liquid crystal display device according to claim 1, wherein
a first photopolymerizable monomer constituting the first monomer unit has two functional groups directly bonded to the structure in which three benzene rings are condensed.

5. The liquid crystal display device according to claim 4, wherein
the two functional groups each have an ethylenic double bond.

6. The liquid crystal display device according to claim 5, wherein
the ethylenic double bond is at an end of the first photopolymerizable monomer.

7. The liquid crystal display device according to claim 1, wherein
a first photopolymerizable monomer constituting the first monomer unit is represented by formula (I):
P¹−A¹−(Z¹−A²)ₙ−P² (I)
wherein
P¹ and P² each independently represent an acrylate group, a methacrylate group, a vinyl group, a vinyloxy group, an acrylamide group, or a methacrylamide group,
A¹ and A² each independently represent an anthrylene group, a phenanthrylene group, or a phenalenediyl group, each of the groups optionally having a substituent,
Z¹ represents —COO—, —OCO—, or a single bond, and
n represents 0, 1, or 2.

8. The liquid crystal display device according to claim 7, wherein
in formula (I), P¹ and P² each independently represent an acrylate group or a methacrylate group, Z¹ represents a single bond, and n represents 0 or 1.

9. The liquid crystal display device according to claim 1, wherein
the photopolymer film is a copolymer further containing a second monomer unit that does not have a structure in which three benzene rings are condensed.

10. The liquid crystal display device according to claim 1, wherein
the photopolymer film is a homopolymer containing the first monomer unit.

11. The liquid crystal display device according to claim 1, wherein
at least one of the pair of substrates comprises an alignment film on the photopolymer film on the side opposite to the liquid crystal layer.

12. The liquid crystal display device according to claim 11, wherein
the alignment film is a vertical alignment film.

13. The liquid crystal display device according to claim 11, wherein
the alignment film is a photo-alignment film.

14. The liquid crystal display device according to claim 1, wherein
the liquid crystal layer contains nematic liquid crystals with negative dielectric anisotropy.

15. A liquid crystal display device comprising
a pair of substrates, and
a liquid crystal layer sandwiched between the pair of substrates, wherein
at least one of the pair of substrates has a photopolymer film formed by polymerizing a photopolymerizable monomer, on a surface on the liquid crystal layer side, and
the photopolymerizable monomer includes a first photopolymerizable monomer having a structure in which three benzene rings are condensed.

16. A composition for forming a liquid crystal layer, for use in formation of a liquid crystal layer sandwiched by a pair of substrates, the composition comprising
a first photopolymerizable monomer having a structure in which three benzene rings are condensed.
